(19) United States
(12) Patent Application Publication
(10) Pub. No.: US 2010/0119991 A1
(43) Pub. Date: May 13, 2010

(54) TOOTH ROOT TIP EXTRACTOR AND METHOD

(76) Inventors: Tarrie Fletcher, Washington, UT (US); Jeffery D. Orr, St. George, UT (US)

Correspondence Address: KARL R CANNON, PO BOX 1909, SANDY, UT, 84091, US

(21) Appl. No.: 12/269,030

(22) Filed: Nov. 11, 2008

(51) Int. Cl. A61C 3/02

(52) U.S. Cl. 433/145

(57) ABSTRACT

An extraction device and method for extracting some or all of a tooth from a patient, such as the root of the tooth, are disclosed. One embodiment of the device includes an extraction burr having helical structure with a positive slope transition portion, and in that manner is distinguishable from a common screw. The helical structure may be configured and shaped such that there is little frictional force placed on the burr as it enters into a tooth. Once the burr enters the tooth the configuration and shape of the burr may provide for increased friction between the tooth structure and the burr, thereby causing the burr to grip the tooth structure and maintain the burr as he tooth is extracted. The extraction burr may include a partial-spiral flute or groove formed in a tip thereof. A lockable and releasable hand piece for attaching to the extraction burr provides leverage to the user for dislodging the tooth root, and is adjustable in at least three different indexable positions in its attachment position with respect to the extraction burr.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE DISCLOSURE

1. The Field of the Disclosure

The disclosure relates generally to tooth extraction devices and methods, and more particularly, but not necessarily entirely, to a tooth root tip extractor and method for extracting tooth roots, including severed tooth roots, from the mouth of a patient.

2. Description of Related Art

A common problem in the field of dentistry occurs when the crown of a tooth breaks apart from the root of the tooth, thereby resulting in the root being left behind and embedded in the bone (i.e., in the maxilla, upper jaw, or the mandible, lower jaw). This can occur in several different settings, such as during a formal tooth extraction procedure by a dentist, or when the crown of a tooth is inadvertently fractured loose during physical activity, or in any other manner.

It is common for the root of a tooth to fuse directly to the jaw bone, causing the root to break along a severance path or fracturing the tooth during extraction. When a tooth root has been severed or fractured, an amount of the tooth root is left behind in the jaw bone (i.e., in the maxilla, upper jaw, or the mandible, lower jaw) after removal of the majority of the tooth. A substantial amount of effort is required to extract the severed tip of the root that remains embedded into the jaw bone, especially when it has fused with the jaw bone.

Conventional methods of extracting the broken tip of the root include simply drilling out part of the jaw bone and digging out the root tip with a sharp tool known as a tooth root “pick” or “elevator.” Such tooth root extraction devices and procedures are unsophisticated, and perhaps even crude in nature, causing significant trauma to a patient. Yet these devices and procedures are still being used today. For instance, a tooth root pick may be used simply to pry the severed tooth root loose from the jaw bone, which often causes painful trauma and damage to surrounding gum tissue and to the jaw bone.

In some cases, dentists will loosen the tooth root with the tooth root pick, then use a tooth root pick elevator to elevate the tooth root and use forceps to grasp the tooth root and extract it. This procedure requires the dentist to drill out a sufficient amount of jaw bone with a conventional dental drill to make room for the bulky forceps and root pick elevator to access the tooth root.

Such procedures cause a significant amount of the jaw bone and associated nerves, blood vessels and other tissues to be needlessly removed and damaged sometimes causing a “dry socket” condition which prevents blood from clotting in the extraction site. There is of course increased trauma to the patient, and a slower healing process, as a result. These procedures are not only crude in nature, but also require a lot of time, and therefore more money in terms of the dentist's time to perform the procedure.

Attempts have been made to overcome the disadvantages of using the tooth root pick, forceps and other devices that tend to needlessly cause increased trauma and damage to the tissues of the patient. For example, prior devices use tooth root extractors having a threaded screw-like member that can be rotatably screwed into the tooth root and lodged therein, after which the user extracts the screw-like member and thereby lifts the root from the jaw bone.

Such devices have not caught on in the field of dentistry, and are characterized by disadvantages. The screw member may introduce a splitting action within the tooth root as it is wedged into the tooth root, and thereby achieves an unstable grip within the tooth. Sometimes the screwing and splitting action will actually cause the root to split apart prematurely, thereby further complicating the extraction procedure. Despite the advantages of known systems and devices, improvements are still being sought.

The known devices are thus characterized by disadvantages that may be addressed by this disclosure. The disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 illustrates an embodiment of a burr in accordance with the principles of the disclosure;

FIG. 1A illustrates a profile of an embodiment of a burr having a plurality of helix structures;

FIG. 1B illustrates a profile of an embodiment of a burr having a helical structure;

FIG. 2 illustrates an embodiment of a burr having a neck portion in accordance with the principles of the disclosure;

FIG. 3 illustrates an embodiment of a complementary hand piece to be used with a burr;

FIG. 4 illustrates an embodiment of a complementary hand piece to be used with a burr;

FIG. 5 illustrates an embodiment of a component of a complementary hand piece to be used with a burr;

FIG. 6 illustrates a sectional view showing the profile of a helical structure;

FIG. 7 illustrates a sectional view showing the profile of a helical structure;

FIG. 8 illustrates a sectional view showing the profile of a helical structure;

FIG. 9 illustrates a helical structure of a burr;

FIG. 10 illustrates an embodiment of a burr in accordance with the principles of the disclosure;

FIG. 11 illustrates an embodiment of a burr in accordance with the principles of the disclosure;

FIG. 12 illustrates an embodiment of a burr in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present device and method for extracting tooth roots are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

U.S. Pat. No. 6,019,602 is hereby incorporated by reference herein in its entirety, with the following exception: In the event that any portion of U.S. Pat. No. 6,019,602 is inconsistent with this application, this application supercedes said portion of U.S. Pat. No. 6,019,602. U.S. Pat. No. 6,019,602 is provided solely for its disclosure prior to the filing date of the present application. Nothing herein is to be construed as a suggestion or admission that the inventors are not entitled to antedate such disclosure by virtue of prior disclosure, or to distinguish the disclosure from the subject matter disclosed in the U.S. Pat. No. 6,019,602.

It must be noted that, as used in this specification and the appended claims, the singular forms “a,” “an,” and “the” include plural referents unless the context clearly dictates otherwise.

In describing and claiming the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

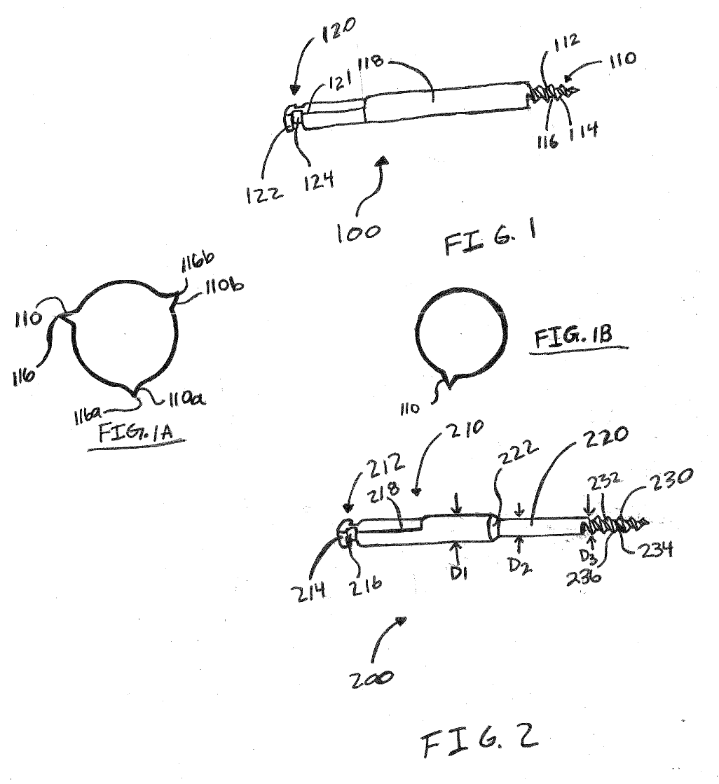

Referring now to FIG. 1, an embodiment of a device for extracting at least a portion of a tooth (sometimes referred to as “tooth portion”) will be discussed. A burr 100 may comprise a helical structure 110 wherein said helical structure may comprise a first surface 112 and a substantially opposing second surface 114 that intersect with each other to form a cutting edge 116. A burr is a boring device or instrument. The burr 100 may further comprise a body portion 118 and an attachment structure 120 wherein the body portion 118 is disposed between said helical structure 110 and said attachment structure 120. The body portion may have a diameter equal to or larger than said the diameter of the helical revolutions of the helical structure 110. It is to be understood that the phrase “diameter of revolution” as used herein shall refer to the diameter of a revolution, whether the revolution be helical or non-helical, and with the understanding that a continuously narrowing series of revolutions (helical or otherwise) could have a large (even infinite) number of decreasing diameters of revolution. In the latter case, the diameter of revolution of a winding surface (such as edge 116) at a certain point, perhaps determinable by (or corresponding to) the degree of curvature and the arc length of a section of curve where the point is a midpoint of the arc length, is different than the diameter of revolution at a point on the revolution near or adjacent to said certain point. Of course, a series of revolutions of constant diameter could also be used to comprise the edge 116, such that a diameter of revolution of edge 116 may be constant or varying, as desired. The attachment structure 120 may comprise complementary structures 122, 124 that provide a gripping means whereby the burr 110 may be used in conjunction with another tool or component.

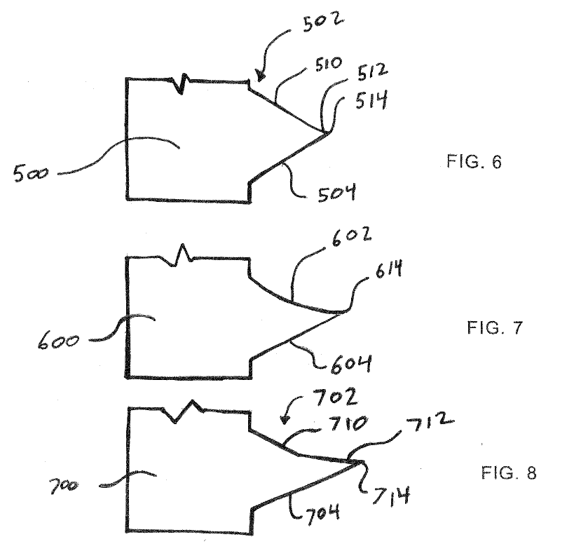

The helical structure 110 may comprise the first surface 112 and the second surface 114, which substantially opposes the first surface 112. The first surface 112 and the second surface 114 may intersect with each other to form a cutting edge 116. The profile of the first surface 112 may have a positive slope transition portion therein, as illustrated in FIGS. 6-8, such that the cutting edge 116 may be configured and dimensioned to reduce friction between the burr 100 and the tooth portion as the burr 100 is inserted into the tooth portion and also to increase friction between the burr 100 and the tooth portion as the burr 100 is manipulated, whether by hand or by a device, to extract the tooth portion. It will be appreciated that one example of a positive slope transition may result in a concave or cupped shape, which may provide a biting effect when inserted into a portion of a tooth.

The helical structure 110 may comprise a first surface 112 and a substantially opposing second surface 114 that intersect with each other to form a cutting edge 116. The first surface 112 may have a positive slope transition portion in the profile thereof, as illustrated for example in FIGS. 6-8, such that the cutting edge 116 is configured to reduce friction between the burr 100 and tooth portion as the burr 100 is inserted into the tooth portion and to increase friction between the burr 100 and the tooth portion as the burr 100 is manipulated to extract the tooth portion.

The burr 100 may comprise a plurality of helix structures, as shown for example in FIG. 1A as reference numerals 110, 110a, 110b, to provide additional cutting edges, for example 116, 116a, 116b as shown in FIG. 1A, and load bearing surfaces at the tip of the burr. It is to be understood that “helix” may refer to an edge 116 having either a constant or a varying diameter of revolution. The plurality of helix structures may be parallel at corresponding points along their lengths in order to provide an even distribution of force on to the tooth portion. The body 118 may also include a bearing structure 121 for inducing or preventing the rotation of the burr 100. This bearing structure 121 may be a recess, a flat, a protrusion or other structures used for inducing or preventing the rotation of the burr 100.

With reference to FIG. 2, an embodiment of a burr 200 having a neck portion is illustrated and will be discussed. A burr 200 may comprise a helical structure 230 wherein said helical structure 230 may comprise a first surface 232 and a substantially opposing second surface 234 that intersect with each other to form a cutting edge 236. The burr 200 may further comprise a body portion 210 and an attachment structure 212. The burr 200 may further comprise a neck portion 220, wherein the neck portion 220 is disposed between the helical structure 230 and the body portion 210. The body portion 210 may have a diameter D1 that is larger than a diameter D2 of the neck portion 220. The diameter D2 of the neck portion 220 may be equal to or greater than a diameter D3 of any of the helical revolutions of the helical structure 230. The attachment structure 212 may comprise complementary structures 214, 216 that provide a gripping means whereby the burr 210 may be used in another tool or component.

The helical structure 230 may comprise the first surface 232 and the second surface 234, which substantially opposes the first surface 112. The first surface 232 and the second surface 234 may intersect with each other to form a cutting edge 236. The profile of the first surface 232 may have a positive slope transition portion therein, as illustrated in FIGS. 6-8, such that the cutting edge 236 may be configured and dimensioned to reduce friction between the burr 200 and the tooth portion as the burr 200 is inserted into the tooth portion and also to increase friction between the burr 200 and the tooth portion as the burr 200 is manipulated, whether by hand or by a device, to extract the tooth portion.

A plurality of helix structures may be included to provide additional cutting surfaces and load bearing surfaces at the tip of the burr. The plurality of helix structures may be parallel at corresponding points along their lengths in order to provide an even distribution of force on to the tooth portion. The neck portion 220 may have the same diameter D2 as a diameter D1 of a revolution of the helical structure. The body 210 may also include a bearing structure 218 for inducing or preventing the rotation of the burr 200. This bearing structure 218 may be a recess, a flat, or a protrusion or other structures used for inducing or preventing the rotation of the burr 200.

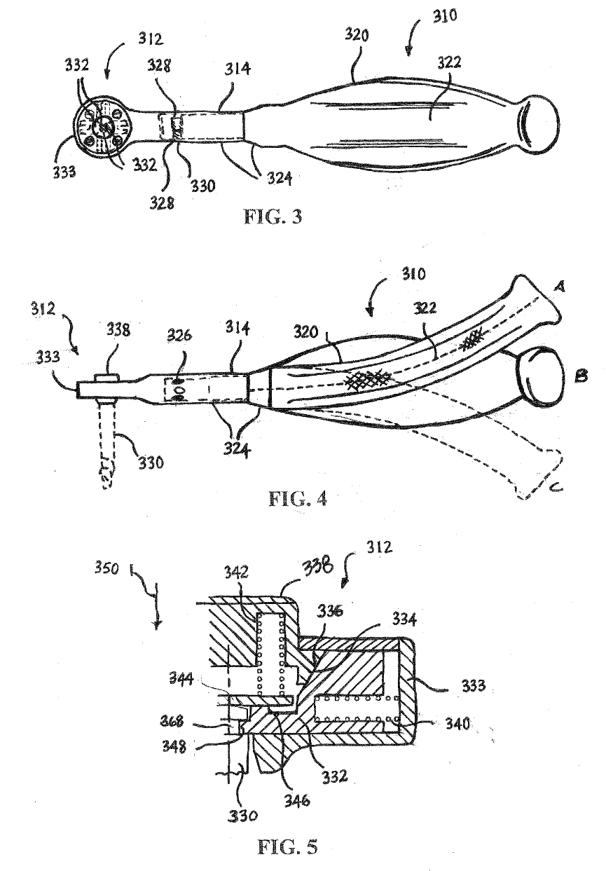

Referring now to FIGS. 3-5, an embodiment of complementary components that may be used in a system or kit will be discussed. A hand piece 310, which operates as an extraction handle for attaching to a burr 330 during use is shown in FIG. 3. The hand piece 310 may include a head 312, which operates as a gripping means for gripping an extraction burr 330 when the burr 330 is embedded in a tooth portion that is to be extracted from a patient's mouth, such that a proximal portion 314 of the head 312 or gripping means extends laterally outward from the burr 330 (shown in phantom line in FIG. 4) during use.

The hand piece 310 may further include a handle 320 defining a central axis 322 at a distal end 324 thereof. The distal end 324 of the handle 320 may be configured and dimensioned to receive the proximal portion 314 of the head 312. An indexing structure 326 may be disposed on the distal end 324 of the handle 320 and may be provided for locking the proximal portion 314 of the head 312 to said handle 320 at three or more selectable positions of said proximal portion 314 about the central axis 322 of the handle 320. Accordingly, the handle 320 and the head 312 may be releasably attached to one another by the indexing structure 326.

The handle 320 may comprises an elongate, reversible handle member, as shown most clearly in FIG. 4. The indexing structure 326 may comprise a biased member 328 disposed in the distal end 324 of the handle 320. The proximal portion 314 of the head 312 may include three or more apertures 326 that may be formed therein, which may be configured and positioned to be aligned with the biased member 328.

Accordingly, the user may adjust the position of the head 312 relative to the handle 220, and the axis 322 of the handle 220. The adjustment may be executed by depressing the biased member 328, releasing the biased member 328 from the aperture 326 and rotating the head 312 relative to the distal end 324 of the handle 320 about the axis 322, until the biased member 328 is aligned with a desired aperture 326. Once the biased member 328 is aligned with an aperture 326, the biased member 328 is ejected into aperture 326 by a spring portion 330 to thereby releasably secure the head 312 in position relative to the handle 320.

The proximal end 314 of the head 312 may include a receiving chamber formed therein. The receiving chamber may be configured and adapted to receive the distal end 324 of the handle 320. The apertures 326 may be formed in a sidewall defining the receiving chamber of the proximal end 314 for receiving the biased member 328 therethrough when aligned with a pin portion of the biased member 328. The proximal end 314 of the head 312 may be designed to have at least three apertures 326 positioned either substantially equidistant from or opposite one another on opposing sides of the proximal end 314 in a symmetrical manner, to thereby permit incremental positioning of the head 312 relative to the handle 320. Alternatively, it will be appreciated that the apertures 326 may be formed in an asymmetrical manner. In a further alternative, there may be four apertures 326 or several apertures 326 formed in the proximal end 314 of the head 312 to permit incremental positioning of the head 312 relative to the handle 320.

As shown most clearly in FIG. 3, the head 312 may include a plurality of sliding members 332 and structures for sliding the sliding members 332. The structures may slide the sliding members 332 radially inward into a locking position about the burr 330 to releasably attach the burr 330 to the head 312 of the hand piece 310. Conversely, the structures may slide the sliding members 332 radially outwardly into a releasing position to release the burr 330 from the head 312 of the hand piece 310.

The operative features of the head 312 are shown more clearly in FIG. 5. The sliding members 332 may each include a beveled contacting face 334, which may engage a corresponding beveled contacting face 336 of a button 338. As shown in FIG. 3, there may be three separate sliding members 332 slidably disposed in a casing 333 of the head 312. Each sliding member 332 may be biased by a lateral spring member 340 shown in FIG. 5. The button 338 may rest upon the beveled contacting faces 334 of the sliding members 332, and also upon axial spring members 342. The axial spring members 342 may be disposed between the button 338 and a stopping plate 344 and in turn the stopping plate 344 may rest in slidable engagement upon ribs 346 of the sliding members 332.

As such, when the extraction burr 330 is inserted into the head 312 it may abut the stopping plate 344. In this position, the burr 330 may be held in position by a recess 368, which may be annular and formed within the attachment structure of the burr 330, being in alignment with lateral contacting faces 348 of the sliding members 332. To insert or release the extraction burr, the button 338 may be pressed downwardly (in the direction indicated by arrow 350 in FIG. 5) to force the sliding members outward, causing engagement along the beveled contacting planes between surfaces 334 and 336. The engagement between surfaces 334 and 336 causes the lateral contacting faces 348 to be removed from recess 368 when releasing the burr 330 or causes the lateral contacting faces 348 to move sufficiently to permit insertion of the attachment structure of the burr 330 into the head 312 and against the stopping plate 344. During insertion, once the burr 330 resides against the plate 344 with the annular recess 368 in alignment with the lateral contacting faces 348 of the sliding members 332, and button 338 is released by the user to permit the lateral contacting faces 348 of the sliding members 332 to slide into position within the annular recess 368 of the burr 330, the burr 330 is releasably locked within the head 312.

In operation, the burr 330 may be inserted within a dental drill, which the operator actuates to induce either a low-speed or high-speed rotational movement to the burr 330 about its elongate axis. The operator, typically a dentist, then applies the rotating burr 330 to the tooth portion. Once a sufficient portion of the helical structure of the burr 330 is properly embedded into the tooth portion with a drill, the drill may be removed. The burr 330 may be further turned by hand, or with the aid of a manually operable gripping tool, which may illustratively comprise a wrench, in order to refine the position of the burr 330 within the tooth portion. The gripping tool is thus configured and adapted for gripping the burr 330 when the burr 330 is at least partially embedded within a portion of the tooth of a patient.

When the burr 330 is properly lodged within the tooth portion to the operator's satisfaction, the hand piece 310 may be releasably locked to the attachment structure 212 of the burr 330. At this point, the handle 320 may extend laterally outward from the burr 330. The operator may grasp the handle 320 to manipulate the burr 330 and to lift and elevate the tooth portion from the mouth of the patient. The head 312 of the hand piece 310 and its internal working structure as explained above collectively provide the advantages of a quick engagement and release of the head 312 to the burr 330. The operator may press the button 338 to slide the sliding members 332 radially outward enough to permit entry of the attachment structure 212 of the burr 330 into the head and into position against the stopping plate 344 as shown in FIG. 5.

The handle 320 may be provided with an arch as illustrated in FIG. 4. The arch of the handle 320 may aid the operator in providing an optimal lifting force to the tooth portion, in that the operator may choose whichever point along the arched portion is optimal according to experience to grip and lift as may best suit the particular position of the tooth portion and the configuration of the patient's mouth. The operator may position the arch of the handle 320 to extend upwardly from the patient's mouth when extracting a root from the upper teeth of the patient. The handle 320 may be conversely positioned downwardly from the patient's mouth when extracting a root from the lower teeth. The versatility of applicant's disclosure permits the operator to use the single hand piece 310 regardless of whether the tooth portion to be extracted resides among the upper or lower teeth or in the anterior or posterior portion of the patient's mouth. This versatility is due, at least in part, to the number of apertures 326 corresponding to a number indexable positions that the head 312 may be moved in relation to the handle 320. The handle 320 may also be re-positioned with respect to the head 312, by utilizing the indexing mechanism, including the biased member 328 and apertures 326, as explained above.

An embodiment may have a hand piece 310, with a handle 320, having an indexable head portion 312, wherein the indexable head portion 312 comprises four holes or apertures 326 or four distinct indexable positions, thereby allowing the user of the device to extract teeth in the following areas of a patient's mouth: (1) the posterior portion of the upper jaw (consisting of teeth #1-#5 and #12-#16); (2) the anterior portion of the upper jaw (consisting of teeth #6-#11); (3) the posterior portion of the lower jaw (consisting of teeth #17-#21 and #28-#32); and (4) the anterior portion of the lower jaw (consisting of teeth #22-#27), depending upon the position of the head portion 312 with respect to the handle 320. It will be appreciated that the indexing mechanism for indexing the head portion 312 relative to the handle 320, may comprise a male portion, such as a biased member 328, and a female portion, such as apertures 326. The body or the handle 320 of the hand piece 310 may comprise either the male portion or the female portion, while the indexable head portion 312 may comprise the opposite one of the male portion and the female portion. The embodiment may have indexed positions that are radially equally placed. The embodiment may have indexed positions that are radially asymmetrically placed.

In accordance with the features and combinations described above, a method of extracting at least a portion of a tooth from a mouth of a patient comprises the steps of:

(a) boring a hole into the portion of the tooth with a boring instrument and displacing tooth particulates with said boring instrument, without splitting said portion of the tooth, and lodging the boring instrument into a position of stability in the portion of the tooth, wherein the boring instrument comprises a helical structure having a first surface comprising a positive slope transition portion in the profile thereof; and

(b) extracting the portion of the tooth by retracting the boring instrument from the mouth of the patient.

Another method of extracting at least a portion of a tooth from a mouth of a patient comprises the steps of:

(a) boring a hole into the portion of the tooth with a motorized boring instrument having a partial-spiral flute formed in a tip section thereof without removing any portion of a jaw bone of the patient, and lodging at least a portion of the boring instrument into a position of stability in the portion of the tooth, wherein the boring instrument comprises a helical structure having a first surface comprising a positive slope transition portion in the profile thereof; and

(b) extracting the portion of the tooth by retracting the boring instrument from the mouth of the patient.

A still further method of extracting at least a portion of a tooth from a mouth of a patient comprises the steps of:

(a) inserting a burr into a motorized instrument;

(b) activating the motorized instrument and boring the burr into a portion of a tooth and lodging at least a portion of the burr into a position of stability in the portion of the tooth, wherein the burr comprises a helical structure having a first surface comprising a positive slope transition portion in the profile thereof;

(c) attaching a handle to the burr; and

(d) extracting the portion of the tooth by elevating the handle without maintaining any force-distributing member in a static position against any teeth of the patient.

Additionally the burr may be disposable, such that the burr may be disposed of with the tooth portion attached to the burr so as to avoid costly labor in handling and cleaning the dirty tools.

With reference to FIGS. 6-9, the positive slope transition of the first surface of the helical structure will be discussed. FIG. 6 illustrates a sectional view of the helical structure 110, 230. The profile of the helical structure is shown giving a two dimensional example of the lines defining the shape of the cross-section. The profile of the helical structure is defined by a line 502 representing the first surface 112, 232 of the helical structure 110, 230 and a line 504 representing the second surface 114, 234 of the helical structure 110, 230. It can also be seen that the lines 502 and 504 intersect forming a point 514 that corresponds to cutting edge 116, 236 in three dimensions. Profile line 502 may comprise a linear line portion 510 that transitions into a curved lined portion 512. It is advantageous if the transition between the line portions 510 and 512 is in a more positive slope direction, thereby providing a hooking trend of that line 502, which represents the first surface of the helical structure.

FIG. 7 illustrates a sectional view of the helical structure 110, 230. The profile of the helical structure 110, 230 is shown giving a two dimensional example of the lines defining the shape of the cross-section. The profile of the helical structure is defined by a line 602 representing the first surface 112, 232 of the helical structure 110, 230 and a line 604 representing the second surface 114, 234 of the helical structure 110, 230. It can also be seen that the lines 602 and 604 intersect forming a point 614 that corresponds to cutting edge 116, 236 in three dimensions. Profile line 602 may be curved and defined by an ever increasing positive sloping trend, thereby providing a hooking trend of that line 602, which represents the first surface of the helical structure.

FIG. 8 illustrates a sectional view of the helical structure 110, 230. The profile of the helical structure 110, 230 is shown giving a two dimensional example of the lines defining the shape of the cross-section. The profile of the helical structure 110, 230 is defined by a line 702 representing the first surface 112, 232 of the helical structure 110, 230 and a line 704 representing the second surface 114, 234 of the helical structure 110, 230. It can also be seen that the lines 702 and 704 intersect forming a point 714 that corresponds to cutting edge 116, 236 in three dimensions. Profile line 702 may be divided into two sub-lines 710 and 712 having an angle between them. The angle is oriented to provide an increasing positive sloping trend, thereby providing a hooking structure of that line 702, which represents the first surface of the helical structure.

The purpose of providing a hooking like profile of the first surface 112, 232 of the helical structure 110, 230 is so that the burr 100, 200 is easier to insert into a portion of the tooth than it is to extract the burr 100, 200 from a portion of the tooth. The result is that a user is able get the burr 100, 200 into position with less trauma to the tooth portion and yet provide additional pulling cohesion when extracting the tooth portion.

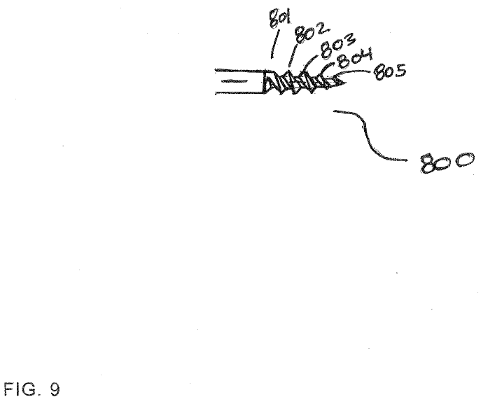

The helical structure 110, 230 may comprise a plurality of revolutions as defined by the helical structure completing a 360 degree rotation about a central axis of the helix. The diameter of a revolution is the measure or the widest portion along the cutting edge of the helix in any given revolution as illustrated in FIG. 2 by diameter D3. As can be seen in FIG. 9 the helical structure 800 in this embodiment is made up of five revolutions. The helical structure may also have revolutions of varying diameters. It can clearly be seen in the figure that revolutions 801, 802, and 803 have greater diameters than revolutions 804 and 805. By providing differing diameters of revolution a user is more easily able to insert a larger working portion of the helix in the pilot hole of a tooth. Further, it will be appreciated that revolutions 801, 802 and 803 may have the same diameter.

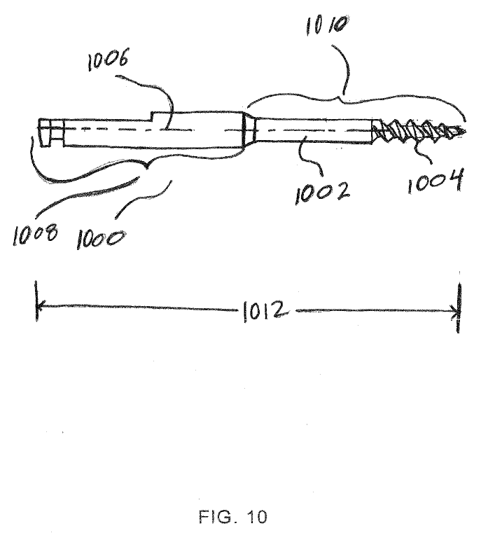

Referring now to FIG. 10, the importance of the proper proportions for the length of the structure will now be discussed. A burr 1000 may comprise a body 1006, a neck 1002 extending from the body 1006, and a helical structure 1004 extending from the neck, wherein the neck and the helical structure define a first length 1010. The body 1006 of the burr 1000 may further comprise a length 1008. The burr 1000 itself may comprise a second length 1012 that is equal to the sum of first length 1010 and the length 1008 of the body 1006. The burr 1000 may comprise a ratio of the second length 1012 to the first length 1010 that is between about 1.5:1 to about 2.25:1. In other words it may be important that the typically wider body portion 1006 of the burr 1000 be one and half times longer than the narrower neck 1002 and helical portion 1004 in order to provide strength to the burr 1000. These proportions ensure that the burr 1000 is reaching the full length of the root in order to extract the root in an atraumatic fashion. If the ratio was not substantially present, then the burr 1000 would either be too long or too short to remove the entire root of the tooth, thereby requiring drilling into the jaw bone and using a lever to pry the tooth out, which is highly traumatic and damaging to the patient's tissues (gums, blood vessels, bone) etc.

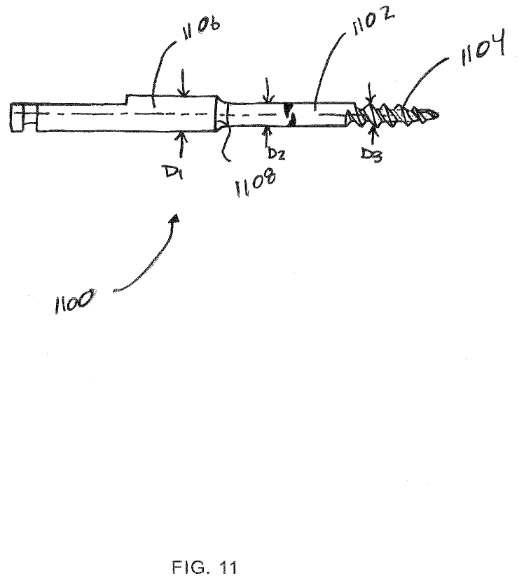

Referring now to FIG. 11 the importance of the proper proportions for the diameters of the structure will now be discussed. A burr 1100 may comprise a body 1106, a neck 1102 extending from the body 1106, and a helical structure 1104 extending from the neck 1102. It may be advantageous for the neck portion 1102 to have the same diameter as the average diameter of the helical portion 1104, to ensure that during use the helical portion 1104 does not experience so much leveraged force as to break the burr 1100. These proportions increase the chances that the neck 1102 is not subjected to forces that could break the burr 1100 along the neck portion 1102. Additionally, such proportions enable the helical portion 1104 to be driven deep enough into a tooth or portion of a tooth without bottoming out on a shoulder 1108. If the ratio was not substantially present, then the burr 1100 would be too wide to remove the entire root of the tooth, thereby requiring drilling into the jaw bone and using a lever to pry the tooth out, which is highly traumatic and damaging to the patient's tissues (gums, blood vessels, bone) etc. These proportions ensure that the burr 1100 is slender enough at the helical structure 1104 and neck 1102 area to fit into a pilot hole and to get down into the broken or fractured root of the tooth in an atraumatic fashion. If the helical portion 1104 and the neck 1102 were not substantially the same size with respect to their diameters, then the burr 1100 would lose strength at the neck 1102 or be too wide at the neck 1102 to enter into the pilot hole.

In an embodiment, a burr device 1100 may have a ratio of the body 1106 diameter to the average diameter of the helical structure 1104 that is between about 1.25:1 to about 1.75:1.

It should also be noted that specific ratios within this range may be selected based on the material the burr is made out of, in order to maximize or minimize any dimension for a particular purpose. A suggested ratio of the body 1106 diameter to the helical structure diameter 1104 is about 1.5:1 to about 1.6:1. In some instances and with some materials it may be critical to ensure that the burr is slender enough to get down into the broken or fractured root of the tooth in an atraumatic fashion. If a precise ratio was not present, then the burr would either be too wide or too narrow to enter into the pilot hole with enough bite and grip to enter into and grasp the tooth and hold on to the tooth during removal of the entire root of the tooth due to the pulling and twisting forces placed on the burr as the tool is manipulated by a dental practitioner.

In another embodiment the burr 1100 may comprise a ratio between the body 1106 diameter, neck 1102 diameter and the helical structure 1104 diameter that is about 1.25:1:1 to about 1.75:1:1. In some instances and with some materials it may be critical to use such a ratio to ensure that the burr is slender enough at the helical structure 1104 and neck 1102 area to fit into a pilot hole and to get down into the broken or fractured root of the tooth in an atraumatic fashion. If the ratios were not present with respect to their diameters, then the burr would lose strength at the neck 1102 or be too wide at the neck 1102 to enter into the pilot hole.

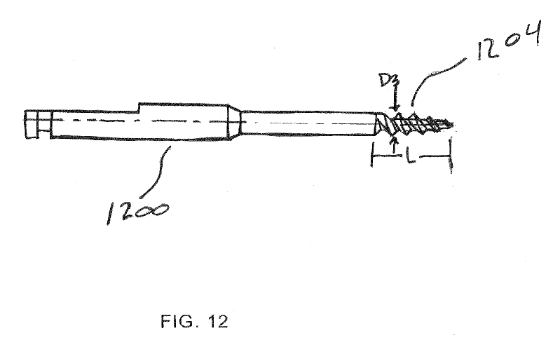

With reference to FIG. 12, an embodiment of a burr that comprises a ratio between the length of the helical structure 1204 and its diameter is between about 2.5:1 to about 6:1 will be discussed. It may be desirable to restrict the overall length “L” of the helical structure 1204 so as to provide enough penetration into a tooth portion, but not so much so as to provide leverage that will break the burr 1200. In use, it would be the goal of the user to have enough of the helical structure 1204, and its corresponding teeth formed by the revolutions of the structure, securely penetrate the tooth portion to be extracted, but not so much that several revolutions of the helical structure 1204 are exposed to the lateral forces exerted thereon when extracting a tooth.

The burrs described in the present disclosure, including burr 100, burr 1100, or burr 1200, may be manufactured from any suitable material. The burrs described in the present disclosure may further be manufactured from any suitable bio-compatible material, including metal, such as titanium, stainless steel, cobalt-chromium-molybdenum alloy, titanium-aluminum vanadium alloy or other suitable metallic alloys, or non-metallic bio-compatible materials such as carbon-fiber, ceramic, bio-resorbable materials or, if desired, any suitable high strength plastic such as an ultra high molecular weight polyethylene. It will be appreciated by those skilled in the art that other bio-compatible materials, whether now known or later discovered, may be utilized by any embodiment of the present disclosure, and said bio-compatible materials are intended to fall within the scope of the present disclosure.

A system using the features and benefits of the above embodiments may include a burr comprising a helical structure, wherein said helical structure of said burr comprise a surface that has a positive profile transition in one direction and a cutting edge, such that the surface and the cutting edge are configured and shaped to reduce friction between said burr and the tooth as said burr is inserted into the tooth and to increase friction between said burr and said tooth when said burr is manipulated to extract the tooth; and a handle that is releasably attachable to said burr for manipulating said burr during extraction of the tooth structure.

An embodiment of a system for extracting at least a portion of a tooth from a patient's jaw bone may include a burr comprising a helical structure, wherein said helical structure of said burr comprise a surface a positive profile sloping transition in one direction and a cutting edge, such that the surface and the cutting edge are configured and shaped to reduce friction between said burr and the tooth as said burr is inserted into the tooth and to increase friction between said burr and said tooth when said burr is manipulated to extract the tooth, rotary device such as a drill that is releasably attachable to said burr for inserting the burr into an tooth structure and a handle that is releasably attachable to said burr for manipulating said burr during extraction of the animal tooth structure.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device for extracting at least a portion of a tooth comprising:
a burr comprising a helical structure;
wherein said helical structure further comprises a first surface having a positive slope transition portion in the profile thereof;
a second surface forming a cutting edge with said first surface such that said first surface, said second surface and said cutting edge are configured to reduce friction between said burr and the tooth portion as said burr is inserted into the tooth portion and to increase friction between said burr and the tooth portion as said burr is manipulated to extract the tooth portion.

2. The device of claim 1 further comprising a plurality of helix structures.

3. The device of claim 2, wherein the plurality of helix structures are parallel at corresponding points along their lengths.

4. The device of claim 1, wherein said first surface of said helical structure comprises a positive slope transition such that said first surface comprises a first line segment and a second line segment wherein said first line segment is at an angle from said second line segment.

5. The device of claim 1, wherein said first surface of said helical structure comprises a positive slope transition such that said first surface comprises a line segment and a positively curved line segment.

6. The device of claim 1, wherein said first surface of said helical structure comprises a positive slope transition such that said first surface comprises a positively curved line segment.

7. The device of claim 1, wherein said helical structure comprises a plurality of revolutions.

8. The device of claim 7, wherein at least one of said plurality of revolutions has a diameter of revolution different than the other revolutions.

9. The device of claim 7, wherein at least one of said plurality of revolutions transitions from a larger diameter of revolution to a smaller diameter of revolution.

10. The device of claim 1 further comprising a neck portion.

11. The device of claim 10, wherein said neck portion has the same diameter as a diameter of a revolution of the helical structure.

12. The device of claim 10, wherein said neck portion has a larger diameter than a diameter of a revolution of the helical structure.

13. The device of claim 1 further comprising a neck portion and a body portion.

14. The device of claim 13, wherein the body portion comprises a length, the neck portion comprises a length and the helical structure comprises a length, wherein the sum of lengths of said neck portion and said helical structure is shorter than the length of said body portion.

15. The device of claim 13, wherein the body portion comprises a length, the neck portion comprises a length and the helical structure comprises a length, wherein the sum of lengths of said neck portion and said helical structure is longer than said body portion.

16. The device of claim 13, wherein the body portion comprises a diameter and the neck portion comprises a diameter, wherein the diameter of said neck portion is less than the diameter of said body portion.

17. The device of claim 1 further comprising a body portion.

18. The device of claim 17, wherein said body portion comprises an attachment structure for attaching to an additional component.

19. The device of claim 17, wherein said body portion comprises a structure for inducing or preventing the rotation of the burr.

20. A device for extracting at least a portion of a tooth from a patient's jaw bone, including:
a burr comprising a body, a neck extending from the body, and a helical structure extending from the neck;
wherein the neck and the helical structure define a first length;
wherein the burr comprises a second length that is equal to the sum of first length and a length of the entirety of the body; and
wherein the burr comprises a ratio of the second length to the first length that is between about 1.5:1 to about 2.25:1.

21. The device of claim 20 further comprising a plurality of helical structures.

22. The device of claim 21, wherein the plurality of helical structures are parallel at corresponding points along their lengths.

23. The device of claim 20, wherein a first surface of said helical structure comprises a positive slope transition, such that said first surface comprises a first line segment and a second line segment, wherein said first line segment is at an angle from said second line segment.

24. The device of claim 20, wherein a first surface of said helical structure comprises a positive slope transition, such that said first surface comprises a line segment and a positively curved line segment.

25. The device of claim 20, wherein a first surface of said helical structure comprises a positive slope transition, such that said first surface comprises a positively curved line segment.

26. The device of claim 20, wherein said helical structure comprises a plurality of revolutions.

27. The device of claim 26, wherein at least one of said plurality of revolutions has a diameter of revolution different than the other revolutions.

28. The device of claim 26, wherein at least one of said plurality of revolutions transitions from a larger diameter of revolution to a smaller diameter of revolution.

29. A device for extracting at least a portion of a tooth from a patient's jaw bone, including:
a burr comprising:
a body having a first diameter;
a neck having a second diameter;
a helical structure;
wherein said helical structure has a third diameter for at least a portion thereof; and
wherein the second diameter and the third diameter are substantially equal.

30. The device of claim 29 further comprising a plurality of helix structures.

31. The device of claim 30, wherein the plurality of helix structures are parallel at corresponding points along their lengths.

32. The device of claim 29, wherein a first surface of said helical structure comprises a positive slope transition, such that said first surface comprises a first line segment and a second line segment wherein said first line segment is at an angle from said second line segment.

33. The device of claim 29, wherein a first surface of said helical structure comprises a positive slope transition, such that said first surface comprises a line segment and a positively curved line segment.

34. The device of claim 29, wherein a first surface of said helical structure comprises a positive slope transition, such that said first surface comprises a positively curved line segment.

35. The device of claim 29, wherein said helical structure comprises a plurality of revolutions.

36. The device of claim 35, wherein at least one of said plurality of revolutions has a diameter of revolution different than the other revolutions.

37. The device of claim 35, wherein at least one of said plurality of revolutions transitions from a larger diameter of revolution to a smaller diameter of revolution.

38. The device of claim 29, wherein the burr comprises a ratio of the first diameter to the third diameter that is between about 1.25:1 to about 1.75:1.

39. The device of claim 29, wherein the ratio of the first diameter to the third diameter is about 1.5:1 to about 1.6:1.

40. A device for extracting at least a portion of a tooth from a patient's jaw bone, including:
a burr comprising a body having a first diameter, a neck having a second diameter, and a helical structure having at least a portion thereof having a third diameter;
wherein the burr comprises a ratio between the first diameter, second diameter and the third diameter that is about 1.25:1:1 to about 1.75:1:1.

41. The device of claim 40 further comprising a plurality of helix structures.

42. The device of claim 41, wherein the plurality of helix structures are parallel at corresponding points along their lengths.

43. The device of claim 40, wherein a first surface of said helical structure comprises a positive slope transition, such that said first surface comprises a first line segment and a second line segment wherein said first line segment is at an angle from said second line segment.

44. The device of claim 40, wherein a first surface of said helical structure comprises a positive slope transition, such that said first surface comprises a line segment and a positively curved line segment.

45. The device of claim 40, wherein a first surface of said helical structure comprises a positive slope transition such that said first surface comprises a positively curved line segment.

46. The device of claim 40, wherein said helical structure comprises a plurality of revolutions.

47. The device of claim 46, wherein at least one of said plurality of revolutions has a diameter of revolution different than the other revolutions.

48. The device of claim 46, wherein at least one of said plurality of revolutions transitions from a larger diameter of revolution to a smaller diameter of revolution.

49. A device for extracting at least a portion of a tooth from a patient's jaw bone, including:
a burr comprising a body, a neck, and a helical structure;
wherein the helical structure comprises a diameter for a portion thereof;
wherein the burr comprises a ratio between its length and the diameter of said helical structure that is between about 2.5:1 to about 6:1.

50. The device of claim 49 further comprising a plurality of helix structures.

51. The device of claim 50, wherein the plurality of helix structures are parallel at corresponding points along their lengths.

52. The device of claim 49, wherein a first surface of said helical structure comprises a positive slope transition, such that said first surface comprises a first line segment and a second line segment wherein said first line segment is at an angle from said second line segment.

53. The device of claim 49, wherein a first surface of said helical structure comprises a positive slope transition, such that said first surface comprises a line segment and a positively curved line segment.

54. The device of claim 49, wherein a first surface of said helical structure comprises a positive slope transition, such that said first surface comprises a positively curved line segment.

55. The device of claim 49, wherein said helical structure comprises a plurality of revolutions.

56. The device of claim 55, wherein at least one of said plurality of revolutions has a diameter of revolution different than the other revolutions.

57. The device of claim 55, wherein at least one of said plurality of revolutions transitions from a larger diameter of revolution to a smaller diameter of revolution.

58. A device for extracting at least a portion of a tooth from a patient's jaw bone, including:
a burr configured for insertion into and for gripping a tooth structure;
a handle comprising:
a body;
a head portion; and
an indexing mechanism;
wherein the head portion comprises a first indexing structure configured to correspond to a second indexing structure of said body, thereby indexing rotation of the head portion relative to said handle portion;
wherein the head portion comprises a burr locking mechanism that is configured for releasably attaching the burr to the handle;
wherein the burr locking mechanism comprises an opening for releasably receiving a portion of said burr therein;
wherein the indexing mechanism indexes said head portion into a plurality of distinct positions relative to the handle, such that the handle is usable in at least three indexed positions for extracting a tooth structure located in one of the following areas of a patient's mouth: (1) the posterior portion of the upper jaw; (2) the anterior portion of the upper jaw; (3) the posterior portion of the lower jaw; and (4) the anterior portion of the lower jaw.

59. The device of claim 58, wherein the first indexing structure is one of a male portion and a female portion and the second indexing structure is the opposite one of the male portion and the female portion.

60. The device of claim 58, wherein indexed positions are radially equally placed.

61. The device of claim 58, wherein indexed positions are radially asymmetrically placed.

62. The device of claim 58 further comprising a plurality of helix structures.

63. The device of claim 62, wherein the plurality of helix structures are parallel at corresponding points along their lengths.

64. A system for extracting at least a portion of a tooth from a patient's jaw bone, including:
a plurality of burrs configured in differing sizes, wherein each burr comprises a helical structure;
wherein said helical structure of each of said burrs comprises a surface that is concave and a cutting edge, such that the surface and the cutting edge are configured and shaped to reduce friction between said burr and the tooth as said burr is inserted into the tooth and to increase friction between said burr and said tooth when said burr is manipulated to extract the tooth; and
a handle that is releasably attachable to said burr for manipulating said burr during extraction of the tooth.

65. The system of claim 64 further comprising a plurality of helix structures.

66. The system of claim 64, wherein the plurality of helix structures are parallel at corresponding points along their lengths.

67. The system of claim 64, wherein said helical structure comprises a plurality of revolutions.

68. The system of claim 67, wherein at least one of said plurality of revolutions has a diameter of revolution different than the other revolutions.

69. The system of claim 67, wherein at least one of said plurality of revolutions transitions from a larger diameter of revolution to a smaller diameter of revolution.

70. A system for extracting at least a portion of a tooth from a patient's jaw bone, including:
a burr comprising a helical structure;
wherein said helical structure of said burr comprises a surface that is concave and a cutting edge, such that the surface and the cutting edge are configured and shaped to reduce friction between said burr and the tooth as said burr is inserted into the tooth and to increase friction between said burr and said tooth when said burr is manipulated to extract the tooth;
a drilling device that is releasably attachable to said burr for inserting the burr into a tooth structure; and
a handle that is releasably attachable to said burr for manipulating said burr during extraction of the tooth.

71. The system of claim 70 further comprising a plurality of burrs having different configurations.

72. A method of extracting at least a portion of a tooth from a patient's jaw bone, including:
securing a burr to a tooth structure, wherein the burr comprises a helical structure;
wherein said helical structure of said burr comprises a surface that is concave and a cutting edge, such that the surface and the cutting edge are configured and shaped to reduce friction between said burr and the tooth structure as said burr is inserted into the tooth structure and to increase friction between said burr and said tooth structure when said burr is manipulated to extract the tooth structure;
attaching the burr to a handle;
manipulating the burr using said handle to extract the tooth structure from the jaw bone of the patient.

73. A device for extracting at least a portion of a tooth comprising:
a burr comprising:
a helical structure;
wherein said helical structure further comprises a first surface having a positive slope transition portion in the profile thereof;
a second surface forming a cutting edge with said first surface such that said first surface, said second surface and said cutting edge are configured to reduce friction between said burr and tooth portion as said burr is inserted into the tooth portion and to increase friction between said burr and said tooth portion as said burr is manipulated to extract the tooth portion;
wherein said helical structure comprises a plurality of revolutions;
wherein at least one of said plurality of revolutions has a diameter of revolution different than the other revolutions;
wherein at least one of said plurality of revolutions transitions from a larger diameter of revolution to a smaller diameter of revolution;
a neck portion;
wherein said neck portion has the same diameter as a diameter of a revolution of the helical structure; and
a body portion;
wherein the body portion comprises an attachment structure for attaching the burr to an additional component;
wherein the body portion comprises a structure for inducing or preventing the rotation of the burr.

74. The device of claim 73, wherein the device further comprises a handle, wherein the handle comprises:
a handle body portion;
a head portion; and
an indexing mechanism;
wherein the head portion comprises a first indexing structure configured to correspond to a second indexing structure of said handle body portion, thereby indexing rotation of the head portion relative to said handle;
wherein the head portion comprises a burr locking mechanism that is configured for releasably attaching the burr to the handle;
wherein the burr locking mechanism comprises an opening for releasably receiving a portion of said burr therein;
wherein the indexing mechanism indexes said head portion into a plurality of distinct positions relative to the handle, such that the handle is usable in at least three indexed positions for extracting a tooth structure located in one of the following areas of a patient's mouth: (1) the posterior portion of the upper jaw; (2) the anterior portion of the upper jaw; (3) the posterior portion of the lower jaw; and (4) the anterior portion of the lower jaw;
wherein indexed positions are radially equally placed;
wherein said neck portion of said burr has a larger diameter than a diameter of at least one revolution of the helical structure;
wherein said neck portion and said helical structure of said burr define a first length;
wherein the burr comprises a second length that is equal to the sum of first length and a length of the entirety of the body; and
wherein the burr comprises a ratio of the second length to the first length that is between about 1.5:1 to about 2.25:1;
wherein the diameter of the neck portion and the diameter of at least a portion of the helical structure of the burr are substantially equal;
wherein the burr comprises a ratio between the diameter of the body portion to the diameter of the neck portion to the diameter of the helical structure that is about 1.25:1:1 to about 1.75:1:1; and
wherein the burr comprises a ratio between its overall length and the diameter of said helical structure that is between about 2.5:1 to about 6:1.

75. The device of claim 1, wherein the positive slope transition of the first surface of the helical structure extends the entire length of said first surface.

76. The device of claim 1, wherein the positive slope transition of the first surface of the helical structure extends less than 50% of the entire length of said first surface.

77. The device of claim 1, wherein the positive slope transition of the first surface of the helical structure extends over 50% of the entire length, but less than the entire length, of said first surface.
